(19) United States
(12) Patent Application Publication
(10) Pub. No.: US 2007/0203252 A1
(43) Pub. Date: Aug. 30, 2007

(54) Anisotropic Shaped Bodies, Method For The Production And Utilization Of Anisotropic Shaped Bodies

(76) Inventors: Oemer Uensal, Mainz (DE); Jorg Belack, Mainz (DE)

Correspondence Address: HAMMER & HANF, PC, 3125 SPRINGBANK LANE, SUITE G, CHARLOTTE, NC, 28226, US

(21) Appl. No.: 11/569,080

(22) PCT Filed: May 13, 2005
(86) PCT No.: PCT/EP05/05283

§ 371 Date: Nov. 14, 2006

(30) Foreign Application Priority Data
May 14, 2004 (DE) 10 2004 024 169.4

(51) Int. Cl. C08J 5/22; H01M 8/10

(52) U.S. Cl. 521/27; 429/33

(57) ABSTRACT

The present invention relates to methods for producing anisotropic shaped bodies, in which a polymer-comprising shaped body is passed through a liquid-filled trough which contains a compound containing at least 2 carbon atoms, wherein the polymers are unwound from one reel and wound onto another reel and the liquid contains monomers containing phosphonic acid groups and/or monomers containing sulphonic acid groups.

The present invention relates to anisotropic shaped bodies, to methods for production and to the use of anisotropic shaped bodies, wherein these may be used in particular as proton-conducting electrolyte membranes and as a membrane in separation methods.

Membranes for technical purposes, such as microfiltration, ultrafiltration, reverse osmosis, electrodialysis and pervaporation for example, are known in general and can be obtained commercially. These membranes frequently serve their purpose, but known membranes separate the particles on the basis of chemical properties or their size. As yet there is no highly loadable, chemically resistant, thermally stable membrane, which separates particles on the basis of their specific shape, for example the length, height and width ratio.

Other membranes include acid-doped polymer membranes, which have diverse uses due to their excellent chemical, thermal and mechanical properties and are particularly suitable as a polymer electrolyte membrane (PEM) in so-called PEM fuel cells.

The basic polyazole membranes are doped with concentrated phosphoric acid or sulphuric acid and act as proton conductors and separators in so-called polymer electrolyte membrane fuel cells (PEM fuel cells).

Due to the excellent properties of the polyazole polymer, such polymer electrolyte membranes can, when processed to produce membrane electrode units (MEUs), be used in fuel cells at long-term operating temperatures above 100° C., in particular above 120° C. This high long-term operating temperature makes it possible to increase the activity of the catalysts based on noble metals which are present in the membrane electrode unit (MEU). Particularly when using so-called reformates of hydrocarbons, significant amounts of carbon monoxide are contained in the reformer gas and these usually have to be removed by means of a costly gas work-up or gas purification. The ability to increase the operating temperature enables significantly higher concentrations of CO impurities to be tolerated over the long term.

The treatment of polyazole films with liquids is described for example in German patent application no. 10234236.9. However, said document describes only polymer membranes which contain a free acid. However, one disadvantage of these membranes is the poor durability of membranes doped with phosphoric acid. Here, the service life is considerably reduced in particular by operating the fuel cell below 100° C., for example at 80° C.

In order to solve these problems, there have been described, for example in German patent application no. 10209419, polymer membranes in which the conductivity is based on polymeric electrolytes, which have a higher level of durability.

The membranes thus obtained already exhibit a good property spectrum. However, improving the overall property spectrum remains a permanent problem.

This property spectrum includes in particular the methanol permeability, the rest potential and the mechanical properties of the membrane.

Furthermore, in the production method described in German patent application no. 10209419, it is disadvantageous that the doping takes place in a relatively complicated manner, wherein in particular a high level of manual work is required. Continuous production of polymer membranes with a high level of durability is not possible or is possible only with great difficulty using the production method described in German patent application no. 10209419.

Due to the swelling of polymer films which contain monomers containing acid groups which is described in German patent application no. 10209419, the mechanical properties of the film change considerably. For example, the modulus of elasticity decreases to 5% of the initial value, so that for example a polyazole film after doping has only a relatively low mechanical stability. Furthermore, the surface area of the film increases by up to 80% as a result of the doping.

Due to these problematic properties, these films were doped with acid in a purely manual method by placing the films in an acid bath and then changing the liquid bath a number of times.

One problem in this method, inter alia, is the high consumption of liquid. Moreover, methods according to the prior art are not very flexible and require a great deal of work. It should be noted here that many polymer films which have a high resistance, such as polyazole films for example, initially exhibit a very low level of flexibility which nevertheless increases as a result of the treatment with acids but results in a loss of mechanical stability.

Furthermore, methods in which products are produced in batches in principle have the problem concerning a constant level of quality.

One object of the present invention is therefore to provide a membrane which separates particles, for example proteins, on the basis of their specific shape, for example the length, height and width ratio. The membrane should be able to withstand high mechanical load, be thermally stable and be chemically resistant, so that this membrane can have various uses.

Another object of the present invention is to provide polymer membranes which have an improved property spectrum, wherein in particular the methanol permeability is reduced, the rest potential is increased and the mechanical properties of the membrane are improved.

Another object of the present invention is to provide methods which solve the aforementioned problems. The method is intended to provide a simple, safe and reliable method for producing polymer membranes.

Also to be provided is a method which can be adapted in a very flexible manner to the mechanical behaviour of the film which changes to a large degree during the treatment, without thereby creating a high level of complexity.

Moreover, the method should have a particularly low consumption of liquid. The method should also be cost-effective.

These objects are achieved by methods for producing proton-conducting electrolyte membranes having all the features of Claim 1.

The present invention accordingly relates to a method for producing anisotropic shaped bodies, in which a polymer-comprising shaped body is passed through a liquid-filled trough, wherein the polymers are unwound from one reel and wound onto another reel, wherein the liquid contains monomers containing phosphonic acid groups and/or monomers containing sulphonic acid groups.

Here, membranes of relatively constant quality can be produced by the present method, wherein a particularly low consumption of liquid is associated with the method. Moreover, the method can be carried out in a cost-effective manner.

The present invention also relates to an anisotropic shaped body obtainable by this method.

The shaped bodies exhibit an excellent property profile. This property spectrum includes in particular the methanol permeability, the rest potential and also the mechanical properties of a membrane. The membranes according to the invention can withstand very high mechanical loads, are thermally stable and are chemically resistant. Moreover, the membranes exhibit an excellent separating performance. Here, the membranes separate particles on the basis of a length, height and width ratio.

In the textile field, the abovementioned procedure is known for example in the context of dyeing. Unlike fabrics, however, a polymer-comprising shaped body, for example a film, is not able to absorb relatively large amounts of liquid within a short time. Furthermore, textile fabrics essentially retain their mechanical properties and change their dimensions only to a small degree during the treatment.

Accordingly, the solution according to the invention is particularly surprising because the method adapts to the changing properties of the polymer-comprising shaped body, for example the film. Moreover, the film comes into contact with the liquid contained in the trough only for a very short time, without this adversely affecting the treatment. Surprisingly, therefore, it must be assumed that the treatment of the polymer-comprising shaped body, for example the film, also takes place in the wound-up state by liquid which is wound up together with the polymer-comprising shaped body, for example the film.

According to the invention, polymer-comprising shaped bodies are treated. Polymer-comprising shaped bodies are known by those in the field. Preferably, the polymer-comprising shaped body is a polymer film.

Preferred polymer films exhibit a swelling by at least 3% in the liquid which contains monomers containing phosphonic acid groups and/or monomers containing sulphonic acid groups. Swelling is understood to mean an increase in weight of the film by at least 3%. The swelling is preferably at least 5%, particularly preferably at least 10%.

The swelling Q is determined gravimetrically from the mass of the film before swelling m₀ and the mass of the film after polymerisation of the monomers containing phosphonic acid groups, m₂.
Q=(m₂−m₀)/m₀×100

The treatment of the polymer films preferably takes place at a temperature above 0° C., in particular between room temperature (20° C.) and 180° C. using a liquid which contains preferably at least 5% by weight of monomers containing phosphonic acid groups. The treatment may also be carried out at increased pressure. Here, the limits will be determined on the basis of economic considerations and technical possibilities.

The polymer film used for the treatment generally has a thickness in the range from 5 to 3000 μm, preferably 10 to 1500 μm and particularly preferably [lacuna]. The preparation of such films from polymers is generally known, with some of these being commercially available. The term polymer film means that the film to be used for the treatment comprises polymers, wherein this film may contain further customary additives.

The preferred polymers which are contained in the shaped bodies, preferably the polymer films, that are treated according to the invention include, inter alia, polyolefins, such as poly(chloroprene), polyacetylene, polyphenylene, poly(p-xylylene), polyarylmethylene, polystyrene, polymethylstyrene, polyvinyl alcohol, polyvinyl acetate, polyvinyl ether, polyvinylamine, poly(N-vinylacetamide), polyvinylimidazole, polyvinylcarbazole, polyvinylpyrrolidone, polyvinylpyridine, polyvinyl chloride, polyvinylidene chloride, polytetrafluoroethylene, polyhexafluoropropylene, copolymers of PTFE with hexafluoropropylene, with perfluoropropylvinyl ether, with trifluoronitrosomethane, with carbalkoxy-perfluoroalkoxyvinyl ether, polychlorotrifluoroethylene, polyvinyl fluoride, polyvinylidene fluoride, polyacrolein, polyacrylamide, polyacrylonitrile, polycyanoacrylates, polymethacrylimide, cyclic olefin copolymers, in particular of norbornene;

polymers containing C—O bonds in the main chain, for example polyacetal, polyoxymethylene, polyether, polypropylene oxide, polyepichlorohydrin, polytetrahydrofuran, polyphenylene oxide, polyether ketone, polyester, in particular polyhydroxyacetic acid, polyethylene terephthalate, polybutylene terephthalate, polyhydroxybenzoate, polyhydroxypropionic acid, polypivalolactone, polycaprolactone, polymalonic acid, polycarbonate;

polymers containing C—S bonds in the main chain, for example polysulphide ether, polyphenylene sulphide, polyethersulphone;

polymers containing C—N bonds in the main chain, for example polyimines, polyisocyanides, polyetherimine, polyetherimides, polyaniline, polyaramides, polyamides, polyhydrazides, polyurethanes, polyimides, polyazoles, polyazole ether ketone, polyazines;

liquid-crystalline polymers, in particular Vectra, and

inorganic polymers, for example polysilanes, polycarbosilanes, polysiloxanes, polysilicic acid, polysilicates, silicones, polyphosphazenes and polythiazyl.

According to one particular aspect of the present invention, use is made of high-temperature-stable polymers which contain at least one nitrogen, oxygen and/or sulphur atom in one or in different repeating units.

Within the context of the present invention, a high-temperature-stable polymer is a polymer which, as polymer electrolyte, can be operated over the long term in a fuel cell at temperatures above 120° C. Over the long term means that a membrane according to the invention can be operated for at least 100 hours, preferably at least 500 hours, at a temperature of at least 120° C., preferably at least 160° C., without more than a 50% decrease in performance based on the initial performance, which performance can be measured according to the method described in WO 01/18894 A2.

The polymers used to produce the films are preferably polymers which have a glass transition temperature or Vicat softening temperature VST/A/50 of at least 100° C., preferably at least 150° C. and very particularly preferably at least 180° C.

Particular preference is given to polymers which contain at least one nitrogen atom in a repeating unit. Special preference is given to polymers which contain at least one aromatic ring with at least one nitrogen heteroatom per repeating unit. Within this group, preference is given in particular to polymers based on polyazoles. These basic polyazole polymers contain at least one aromatic ring with at least one nitrogen heteroatom per repeating unit. According to one particular aspect of the present invention, preferred polymer-comprising shaped bodies, in particular polymer films, comprise at least 80% by weight, in particular at least 90% by weight of polyazoles.

The aromatic ring is preferably a five-membered or six-membered ring with one to three nitrogen atoms, which may be fused to another ring, in particular another aromatic ring.

Polymers based on polyazole contain recurring azole units of the general formula (I) and/or (II) and/or (III) and/or (IV) and/or (V) and/or (VI) and/or (VII) and/or (VIII) and/or (IX) and/or (X) and/or (XI) and/or (XII) and/or (XIII) and/or (XIV) and/or (XV) and/or (XVI) and/or (XVII) and/or (XVIII) and/or (XIX) and/or (XX) and/or (XXI) and/or (XXII) 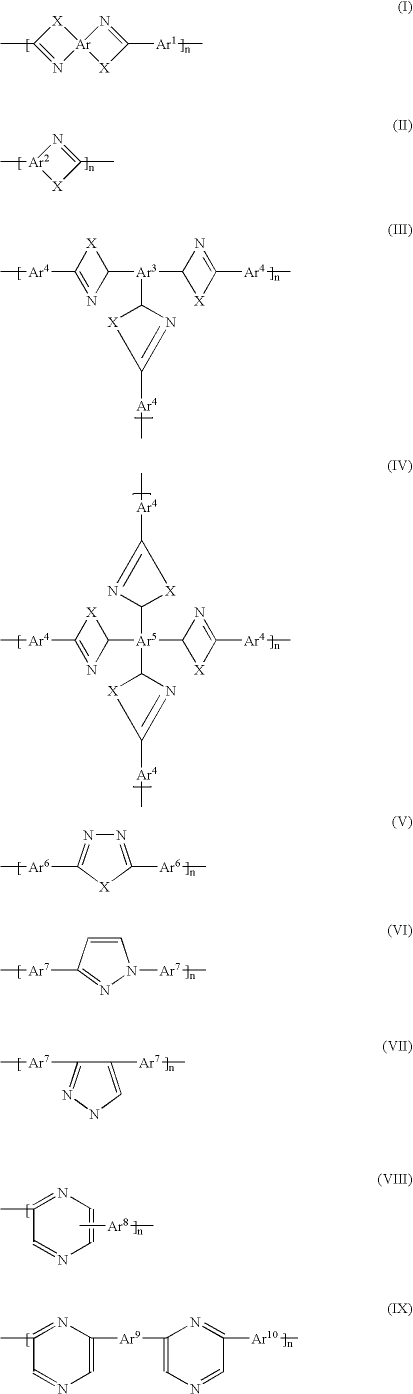 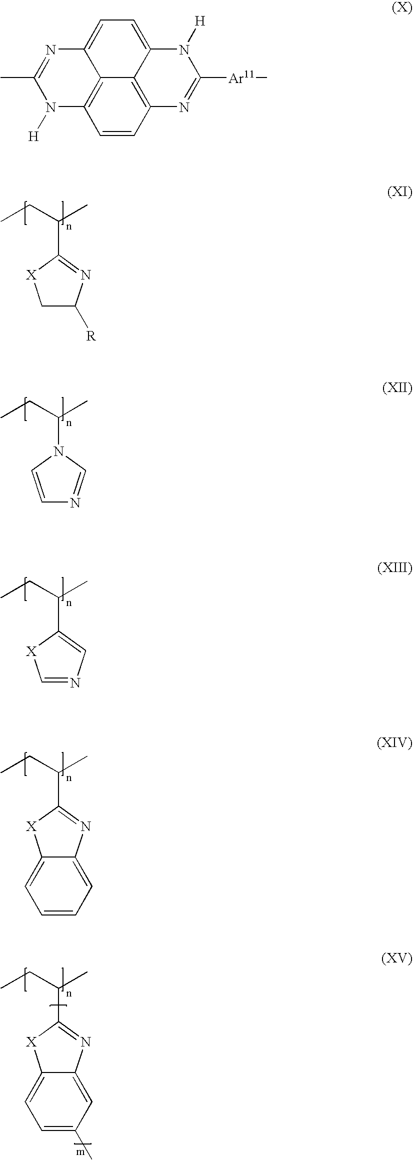 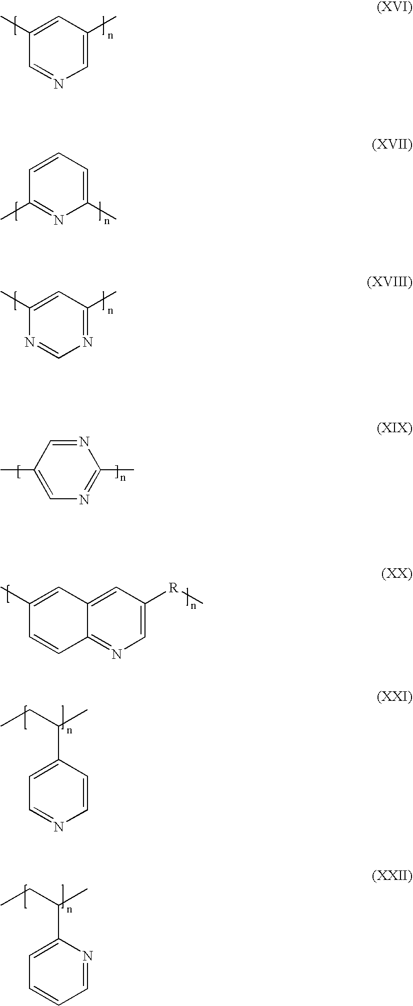
in which
Ar are the same or different and are each a tetravalent aromatic or heteroaromatic group which may be mononuclear or polynuclear,
Ar¹ are the same or different and are each a divalent aromatic or heteroaromatic group which may be mononuclear or polynuclear,
Ar² are the same or different and are each a divalent or trivalent aromatic or heteroaromatic group which may be mononuclear or polynuclear,
Ar³ are the same or different and are each a trivalent aromatic or heteroaromatic group which may be mononuclear or polynuclear,
Ar⁴ are the same or different and are each a trivalent aromatic or heteroaromatic group which may be mononuclear or polynuclear,
Ar⁵ are the same or different and are each a tetravalent aromatic or heteroaromatic group which may be mononuclear or polynuclear,
Ar⁶ are the same or different and are each a divalent aromatic or heteroaromatic group which may be mononuclear or polynuclear,
Ar⁷ are the same or different and are each a divalent aromatic or heteroaromatic group which may be mononuclear or polynuclear,
Ar⁸ are the same or different and are each a trivalent aromatic or heteroaromatic group which may be mononuclear or polynuclear,
Ar⁹ are the same or different and are each a divalent or trivalent or tetravalent aromatic or heteroaromatic group which may be mononuclear or polynuclear,
Ar¹⁰ are the same or different and are each a divalent or trivalent aromatic or heteroaromatic group which may be mononuclear or polynuclear,
Ar¹¹ are the same or different and are each a divalent aromatic or heteroaromatic group which may be mononuclear or polynuclear,
X are the same or different and are each oxygen, sulphur or an amino group which bears a hydrogen atom, a group having 1-20 carbon atoms, preferably a branched or unbranched alkyl or alkoxy group, or an aryl group as further radical,
R is the same or different and is hydrogen, an alkyl group or an aromatic group, with the proviso that R in formula XX is a divalent group, and
n, m are each an integer greater than or equal to 10, preferably greater than or equal to 100.

Aromatic or heteroaromatic groups which are preferred according to the invention are derived from benzene, naphthalene, biphenyl, diphenyl ether, diphenylmethane, diphenyldimethylmethane, bisphenone, diphenylsulphone, thiophene, furan, pyrrole, thiazole, oxazole, imidazole, isothiazole, isoxazole, pyrazole, 1,3,4-oxadiazole, 2,5-diphenyl-1,3,4-oxadiazole, 1,3,4-thiadiazole, 1,3,4-triazole, 2,5-diphenyl-1,3,4-triazole, 1,2,5-triphenyl-1,3,4-triazole, 1,2,4-oxadiazole, 1,2,4-thiadiazole, 1,2,4-triazole, 1,2,3-triazole, 1,2,3,4-tetrazole, benzo[b]thiophene, benzo[b]furan, indole, benzo[c]thiophene, benzo[c]furan, isoindole, benzoxazole, benzothiazole, benzimidazole, benzisoxazole, benzisothiazole, benzopyrazole, benzothiadiazole, benzotriazole, dibenzofuran, dibenzothiophene, carbazole, pyridine, bipyridine, pyrazine, pyrazole, pyrimidine, pyridazine, 1,3,5-triazine, 1,2,4-triazine, 1,2,4,5-triazine, tetrazine, quinoline, isoquinoline, quinoxaline, quinazoline, cinnoline, 1,8-naphthyridine, 1,5-naphthyridine, 1,6-naphthyridine, 1,7-naphthyridine, phthalazine, pyridopyrimidine, purine, pteridine or quinolizine, 4H-quinolizine, diphenyl ether, anthracene, benzopyrrole, benzooxathiadiazole, benzooxadiazole, benzopyridine, benzopyrazine, benzopyrazidine, benzopyrimidine, benzotriazine, indolizine, pyridopyridine, imidazopyrimidine, pyrazinopyrimidine, carbazole, acridine, phenazine, benzoquinoline, phenoxazine, phenothiazine, acridizine, benzopteridine, phenanthroline and phenanthrene, each of which may optionally also be substituted.

In this case, Ar¹, Ar⁴, Ar⁶, Ar⁷, Ar⁸, Ar⁹, Ar¹⁰, Ar¹¹ can have any substitution pattern, in the case of phenylene, for example, Ar¹, Ar⁴, Ar⁶, Ar⁷, Ar⁸, Ar⁹, Ar¹⁰, Ar¹¹ can be ortho-phenylene, meta-phenylene and para-phenylene. Particularly preferred groups are derived from benzene and biphenylene, each of which may also be substituted.

Preferred alkyl groups are short-chain alkyl groups having from 1 to 4 carbon atoms, such as e.g. methyl, ethyl, n-propyl or isopropyl and t-butyl groups.

Preferred aromatic groups are phenyl or naphthyl groups. The alkyl groups and the aromatic groups may be substituted.

Preferred substituents are halogen atoms such as e.g. fluorine, amino groups, hydroxyl groups or short-chain alkyl groups such as e.g. methyl or ethyl groups.

Preference is given to polyazoles having recurring units of the formula (I) in which the radicals X within a recurring unit are identical.

The polyazoles can in principle also have differing recurring units which, for example, differ in their radical X. However, there are preferably only identical radicals X in a recurring unit.

In a further embodiment of the present invention, the polymer containing recurring azole units is a copolymer or a blend which contains at least two units of the formulae (I) to (XXII) which differ from one another. The polymers can be in the form of block copolymers (diblock, triblock), statistical copolymers, periodic copolymers, segmented copolymers and/or alternating polymers.

The number of recurring azole units in the polymer is preferably an integer greater than or equal to 10. Particularly preferred polymers contain at least 100 recurring azole units.

Within the context of the present invention, preference is given to polymers containing recurring benzimidazole units. Some examples of the extremely advantageous polymers which contain recurring benzimidazole units are represented by the following formulae: 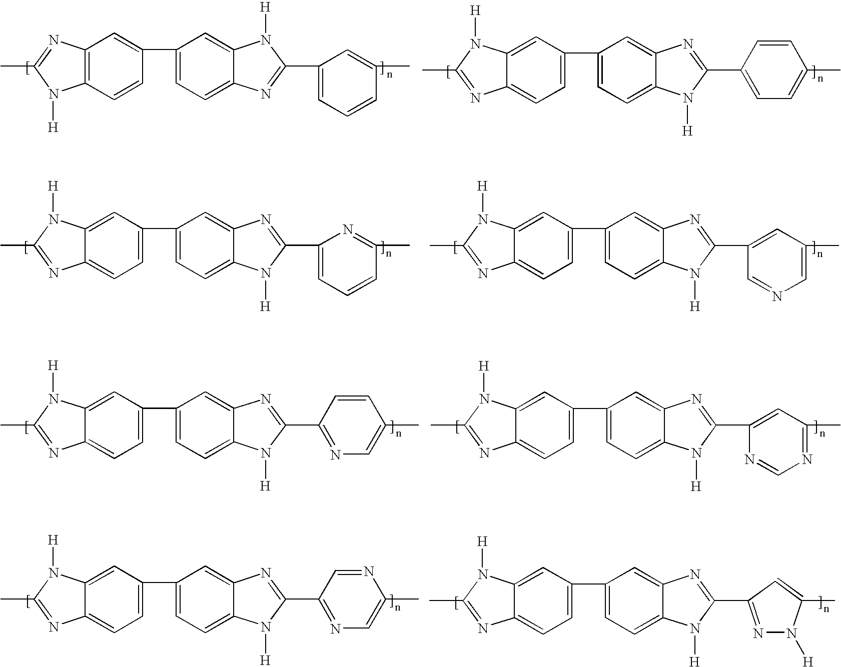 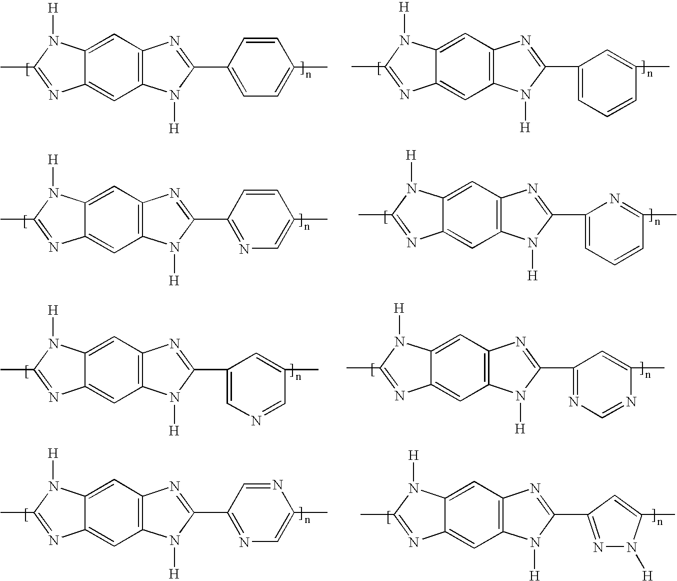 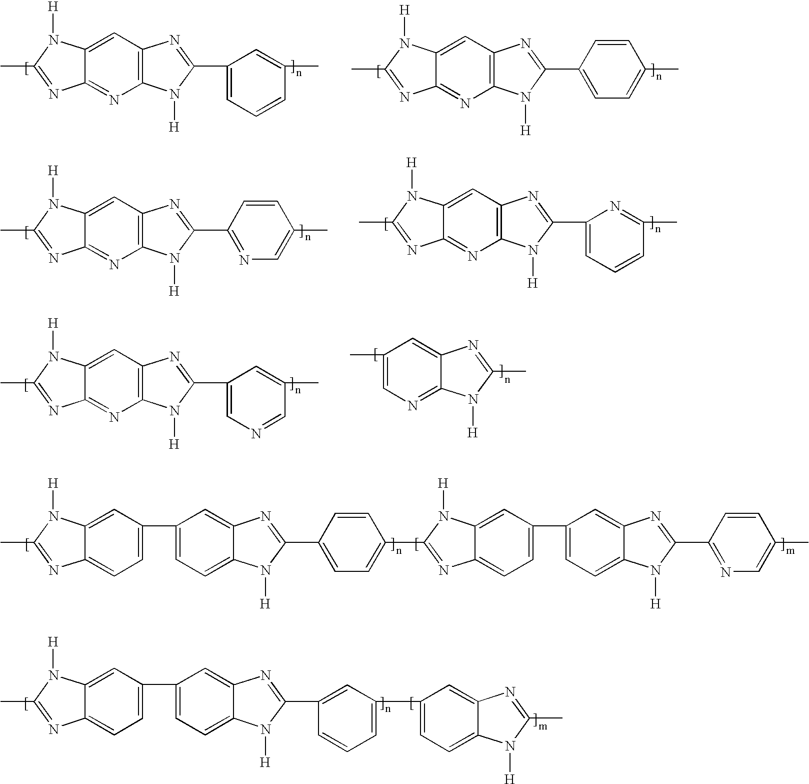
where n and m are each an integer greater than or equal to 10, preferably greater than or equal to 100.

The polyazoles, which are preferably used, but in particular the polybenzimidazoles, are characterised by a high molecular weight. Measured as intrinsic viscosity, this is preferably at least 0.2 dl/g, in particular 0.8 to 10 dl/g, particularly preferably 1 to 5 dl/g.

Further preferred polyazole polymers are polyimidazoles, polybenzothiazoles, polybenzoxazoles, polytriazoles, polyoxadiazoles, polythiadiazoles, polypyrazoles, polyquinoxalines, poly(pyridines), poly(pyrimidines) and poly(tetrazapyrenes).

The preparation of such polyazoles is known, wherein one or more aromatic tetraamino compounds are reacted in the melt with one or more aromatic carboxylic acids or the esters thereof which contain at least two acid groups per carboxylic acid monomer, to form a prepolymer. The resulting prepolymer solidifies in the reactor and is then comminuted mechanically. The pulverulent prepolymer is usually end-polymerised in a solid-phase polymerisation at temperatures of up to 400° C.

Preferred polybenzimidazoles are commercially available under the trade name ®Celazole from Celanese AG.

Particular preference is given to ®Celazole from Celanese, in particular to one in which the polymer worked up by fractionation as described in German patent application no. 10129458.1 is used.

Preference is also given to polyazoles which have been obtained by the methods described in German patent application no. 10117687.2.

The preferred polymers include polysulphones, in particular polysulphone containing aromatic and/or heteroaromatic groups in the main chain. According to one particular aspect of the present invention, preferred polysulphones and polyethersulphones have a melt volume rate MVR 300/21.6 of less than or equal to 40 cm³/10 min, in particular less than or equal to 30 cm³/10 min and particularly preferably less than or equal to 20 cm³/10 min, measured according to ISO 1133. Here, preference is given to polysulphones with a Vicat softening temperature VST/A/50 of 180° C. to 230° C. In another preferred embodiment of the present invention, the number-average molecular weight of the polysulphones is greater than 30 000 g/mol.

The polymers based on polysulphone include in particular polymers which contain recurring units with linking sulphone groups according to general formulae A, B, C, D, E, F and/or G: 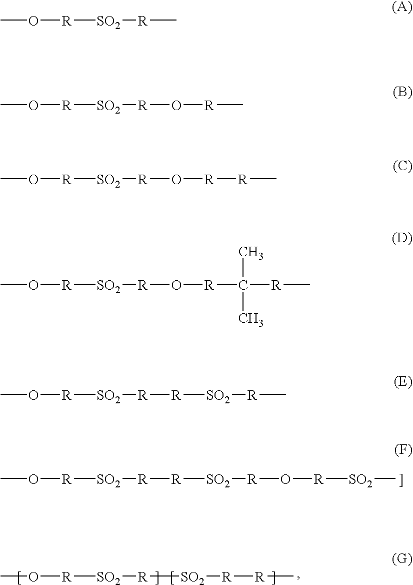
wherein the radicals R independently of one another are identical or different and are an aromatic or heteroaromatic group, said radicals having been explained in more detail above. These include in particular 1,2-phenylene, 1,3-phenylene, 1,4-phenylene, 4,4′-biphenyl, pyridine, quinoline, naphthalene, phenanthrene.

The polysulphones which are preferred within the context of the present invention include homopolymers and copolymers, for example statistical copolymers. Particularly preferred polysulphones comprise recurring units of the formulae H to N: 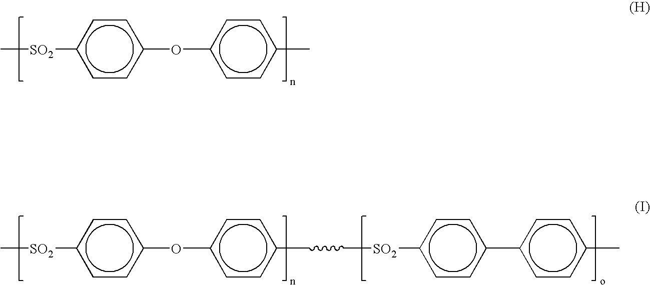
where n>o 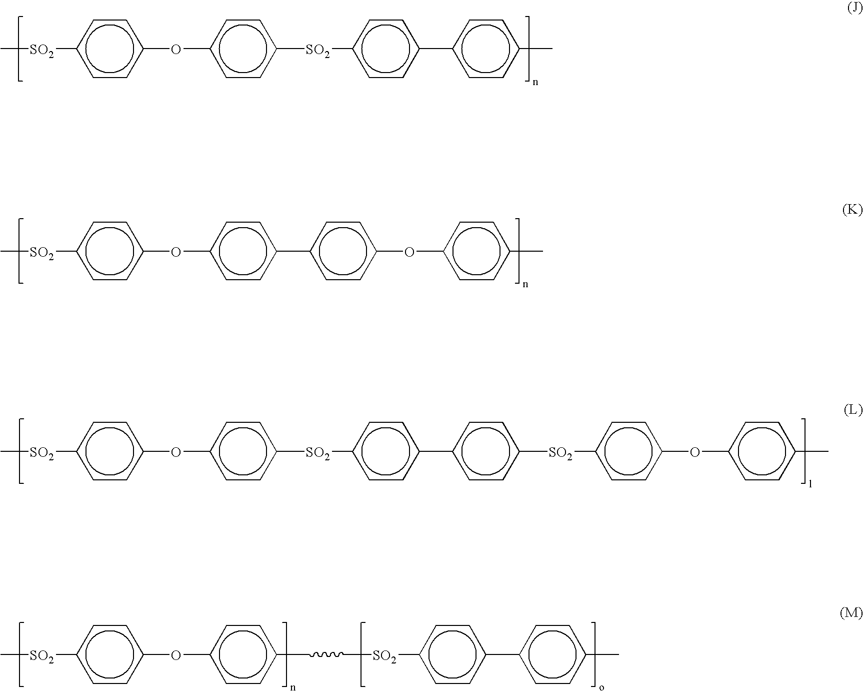
where n<o

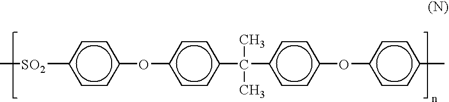

The previously described polysulphones can be obtained commercially under the trade names ®Victrex 200 P, ®Victrex 720 P, ®Ultrason E, ®Ultrason S, ®Mindel, ®Radel A, ®Radel R, ®Victrex HTA, ®Astrel and ®Udel.

Particular preference is also given to polyether ketones, polyether ketone ketones, polyether ether ketones, polyether ether ketone ketones and polyaryl ketones. These high-performance polymers are known per se and can be obtained commercially under the trade names Victrex® PEEK™, ®Hostatec, ®Kadel.

It is also possible to use polymers which contain acid groups. These acid groups comprise in particular sulphonic acid groups. Here, polymers containing aromatic sulphonic acid groups can be used with preference.

Aromatic sulphonic acid groups are groups in which the sulphonic acid group (—SO₃H) is covalently bonded to an aromatic or heteroaromatic group. The aromatic group may form part of the main chain (backbone) of the polymer or may form part of a side group, with preference being given to polymers containing aromatic groups in the main chain. The sulphonic acid groups can often also be used in the form of the salts. It is also possible to use derivatives, for example esters, in particular methyl or ethyl esters, or halides of sulphonic acids, which are converted into the sulphonic acid during operation of the membrane.

The polymers modified with sulphonic acid groups preferably have a content of sulphonic acid groups in the range from 0.5 to 3 meq/g. This value is determined by way of the so-called ion exchange capacity (IEC).

In order to measure the IEC, the sulphonic acid groups are converted into the free acid. To this end, the polymer is treated with acid in the known manner, with excess acid being removed by washing. For example, the sulphonated polymer is firstly treated in boiling water for 2 hours. Excess water is then dabbed off and the sample is dried for 15 hours at 160° C. in a vacuum drying cabinet at p<1 mbar. The dry weight of the membrane is then determined. The polymer dried in this way is then dissolved in DMSO at 80° C. over 1 h. The solution is then titrated with 0.1 M NaOH. The ion exchange capacity (IEC) is then calculated from the consumption of acid up to the equivalent point and the dry weight.

Such polymers are known by those in the field. Polymers containing sulphonic acid groups can be produced for example by sulphonation of polymers. Methods for the sulphonation of polymers are described in F. Kucera et. al. Polymer Engineering and Science 1988, Vol. 38, No 5, 783-792. Here, the sulphonation conditions can be selected such that a low degree of sulphonation is obtained (DE-A-19959289).

A further class of non-fluorinated polymers has been developed by sulphonation of high-temperature-stable thermoplasts. For example, sulphonated polyether ketones (DE-A-4219077, WO96/01177), sulphonated polysulphones (J. Membr. Sci. 83 (1993) p. 211) or sulphonated polyphenylene sulphide (DE-A-19527435) are known.

U.S. Pat. No. 6,110,616 describes copolymers of butadiene and styrene and the subsequent sulphonation thereof for use for fuel cells.

Such polymers can also be obtained by polyreactions of monomers which contain acid groups. For example, perfluorinated polymers as described in U.S. Pat. No. 5,422,411 can be produced by copolymerisation from trifluorostyrene and sulphonyl-modified trifluorostyrene.

These perfluorosulphonic acid polymers include inter alia Nafion® (U.S. Pat. No. 3,692,569). As described in U.S. Pat. No. 4,453,991, this polymer can be brought into solution and then used as ionomer.

The preferred polymers containing acid groups include inter alia sulphonated polyether ketones, sulphonated polysulphones, sulphonated polyphenylene sulphides, perfluorinated sulphonic-acid-group-containing polymers, as described in U.S. Pat. No. 3,692,569, U.S. Pat. No. 5,422,411 and U.S. Pat. No. 6,110,616.

The abovementioned polymers can be used individually or as a mixture (blend). Here, preference is given in particular to blends which contain polyazoles and/or polysulphones. By using blends, the mechanical properties can be improved and the material costs can be reduced.

The polymer-comprising shaped body, for example the polymer film, may additionally contain further modifications, for example due to crosslinking as described in German patent application no. 10110752.8 or in WO 00/44816. In one preferred embodiment, the polymer film which consists of a basic polymer and at least one blend component and which is used for swelling additionally contains a crosslinker as described in German patent application no. 10140147.7.

In addition, it is advantageous if the polymer film used for the treatment is treated beforehand as described in German patent application no. 10109829.4. This variant is advantageous in order to increase the absorption capacity of the polymer film in respect of the monomers containing phosphonic acid groups.

In order to produce polymer films, the aforementioned polymers may inter alia be extruded. Polymer films can also be obtained by means of casting processes. For example, polyazoles can be dissolved in polar, aprotic solvents, such as dimethylacetamide (DMAc) for example, and a film can be produced by conventional methods.

In order to remove residues of solvent, the film thus obtained can be treated with a washing liquid in a first step. This washing liquid is preferably selected from the group consisting of alcohols, ketones, alkanes (aliphatic and cycloaliphatic), ethers (aliphatic and cycloaliphatic), esters, carboxylic acids, wherein the above group members may also be halogenated, water, inorganic acids (such as e.g. H3PO4, H2SO4) and mixtures thereof.

In particular, use is made of C1-C10 alcohols, C2-C5 ketones, C1-C10 alkanes (aliphatic and cycloaliphatic), C2-C6 ethers (aliphatic and cycloaliphatic), C2-C5 esters, C1-C3 carboxylic acids, dichloromethane, water, inorganic acids (such as e.g. H3PO4, H2SO4) and mixtures thereof. Of these liquids, particular preference is given to water.

According to one particular aspect of the present invention, the liquid which is used in a first step comprises at least 70% by weight of water. After washing the polymer film, the treatment liquid is replaced.

After washing, the film can be dried in order to remove the washing liquid. The drying takes place as a function of the partial vapour pressure of the selected treatment liquid. Usually, the drying takes place at normal pressure and at temperatures of between 20° C. and 200° C. Gentle drying may also take place in vacuo. Instead of the drying, the membrane may also be dabbed and thus freed of excess treatment liquid. The sequence is not critical.

Due to the above-described cleaning of the polymer film, in particular of the polyazole film, to remove residues of solvent, the mechanical properties of the film are surprisingly improved. These properties include in particular the modulus of elasticity, the tear strength and the break strength of the film.

As a result, it is also possible to prevent contamination of the treatment liquid by released residues of solvent.

In order to achieve proton conductivity, these films are doped with monomers containing phosphonic acid groups and/or monomers containing sulphonic acid groups. Monomers containing phosphonic acid groups and/or monomers containing sulphonic acid groups are known to those in the field. These are compounds which contain at least one carbon-carbon double bond and at least one phosphonic acid group. Preferably, the two carbon atoms which form the carbon-carbon double bond have at least two, preferably three, bonds to groups which lead to low steric hindrance of the double bond. These groups include inter alia hydrogen atoms and halogen atoms, in particular fluorine atoms. Within the context of the present invention, the polymer containing phosphonic acid groups results from the polymerisation product which is obtained by polymerising the monomer containing phosphonic acid groups alone or with other monomers and/or crosslinkers.

The monomer containing phosphonic acid groups may comprise one, two, three or more carbon-carbon double bonds. The monomer containing phosphonic acid groups may also contain one, two, three or more phosphonic acid groups.

In general, the monomer containing phosphonic acid groups contains 2 to 20, preferably 2 to 10 carbon atoms.

The monomers containing phosphonic acid groups which are used to produce the polymers containing phosphonic acid groups are preferably compounds of the formula 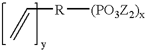
in which
R is a bond, a divalent C1-C15 alkylene group, a divalent C1-C15 alkylenoxy group, for example an ethylenoxy group, or a divalent C5-C20 aryl or heteroaryl group, wherein the above radicals may in turn be substituted by halogen, —OH, COOZ, —CN, NZ₂,
Z independently of one another is hydrogen, a C1-C15 alkyl group, a C1-C15 alkoxy group, an ethylenoxy group or a C5-C20 aryl or heteroaryl group, wherein the above radicals may in turn be substituted by halogen, —OH, —CN, and
x is an integer 1, 2, 3, 4, 5, 6, 7, 8, 9 or 10
y is an integer 1, 2, 3, 4, 5, 6, 7, 8, 9 or 10
   and/or of the formula 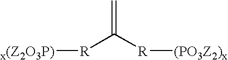
   in which
R is a bond, a divalent C1-C15 alkylene group, a divalent C1-C15 alkylenoxy group, for example an ethylenoxy group, or a divalent C5-C20 aryl or heteroaryl group, wherein the above radicals may in turn be substituted by halogen, —OH, COOZ, —CN, NZ₂,
Z independently of one another is hydrogen, a C1-C15 alkyl group, a C1-C15 alkoxy group, an ethylenoxy group or a C5-C20 aryl or heteroaryl group, wherein the above radicals may in turn be substituted by halogen, —OH, —CN, and
x is an integer 1, 2, 3, 4, 5, 6, 7, 8, 9 or 10
   and/or of the formula 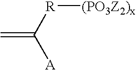
   in which
A is a group of the formula COOR², CN, CONR²₂, OR² and/or R², in which R² is hydrogen, a C1-C15 alkyl group, a C1-C15 alkoxy group, an ethylenoxy group or a C5-C20 aryl or heteroaryl group, wherein the above radicals may in turn be substituted by halogen, —OH, COOZ, —CN, NZ₂
R is a bond, a divalent C1-C15 alkylene group, a divalent C1-C15 alkylenoxy group, for example an ethylenoxy group, or a divalent C5-C20 aryl or heteroaryl group, wherein the above radicals may in turn be substituted by halogen, —OH, COOZ, —CN, NZ₂,
Z independently of one another is hydrogen, a C1-C15 alkyl group, a C1-C15 alkoxy group, an ethylenoxy group or a C5-C20 aryl or heteroaryl group, wherein the above radicals may in turn be substituted by halogen, —OH, —CN, and
x is an integer 1, 2, 3, 4, 5, 6, 7, 8, 9 or 10.

The preferred monomers containing phosphonic acid groups include, inter alia, alkenes which contain phosphonic acid groups, such as ethenephosphonic acid, propenephosphonic acid, butenephosphonic acid; acrylic acid compounds and/or methacrylic acid compounds which contain phosphonic acid groups, such as for example 2-phosphonomethylacrylic acid, 2-phosphonomethylmethacrylic acid, 2-phosphonomethylacrylic acid amide and 2-phosphonomethylmethacrylic acid amide.

With particular preference, use is made of commercially available vinylphosphonic acid (ethenephosphonic acid), as obtainable for example from Aldrich or Clariant GmbH. A preferred vinylphosphonic acid has a purity of more than 70%, in particular 90% and particularly preferably more than 97% purity.

The monomers containing phosphonic acid groups may also be used in the form of derivatives which can subsequently be converted into the acid, wherein the conversion to acid may also take place in the polymerised state. These derivatives include in particular the salts, esters, amides and halides of the monomers containing phosphonic acid groups.

The liquid used for the treatment preferably comprises at least 20% by weight, in particular at least 30% by weight and particularly preferably at least 50% by weight, based on the total weight of the mixture, of monomers containing phosphonic acid groups and/or monomers containing sulphonic acid groups.

The liquid used for the treatment may additionally contain further organic and/or inorganic solvents. The organic solvents include in particular polar aprotic solvents, such as dimethylsulphoxide (DMSO), esters, such as ethyl acetate, and polar protic solvents, such as alcohols, such as ethanol, propanol, isopropanol and/or butanol, The inorganic solvents include in particular water, phosphoric acid and polyphosphoric acid.

These may positively influence the processability. In particular, the absorption capacity of the film in respect of the monomers can be improved by adding the organic solvent. The content of monomers containing phosphonic acid groups and/or monomers containing sulphonic acid groups in such solutions is generally at least 5% by weight, preferably at least 10% by weight, particularly preferably between 10 and 97% by weight.

According to one particular aspect of the present invention, in order to produce the polymers containing phosphonic acid groups, it is possible to use compositions which contain monomers containing sulphonic acid groups.

Monomers containing sulphonic acid groups are known to those in the field. These are compounds which contain at least one carbon-carbon double bond and at least one sulphonic acid group. Preferably, the two carbon atoms which form the carbon-carbon double bond have at least two, preferably three, bonds to groups which lead to low steric hindrance of the double bond. These groups include inter alia hydrogen atoms and halogen atoms, in particular fluorine atoms. Within the context of the present invention, the polymer containing sulphonic acid groups results from the polymerisation product which is obtained by polymerising the monomer containing sulphonic acid groups alone or with other monomers and/or crosslinkers.

The monomer containing sulphonic acid groups may comprise one, two, three or more carbon-carbon double bonds. The monomer containing sulphonic acid groups may also contain one, two, three or more sulphonic acid groups.

In general, the monomer containing sulphonic acid groups contains 2 to 20, preferably 2 to 10 carbon atoms.

The monomers containing sulphonic acid groups are preferably compounds of the formula 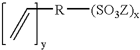
in which
R is a bond, a divalent C1-C15 alkylene group, a divalent C1-C15 alkylenoxy group, for example an ethylenoxy group, or a divalent C5-C20 aryl or heteroaryl group, wherein the above radicals may in turn be substituted by halogen, —OH, COOZ, —CN, NZ₂,
Z independently of one another is hydrogen, a C1-C15 alkyl group, a C1-C15 alkoxy group, an ethylenoxy group or a C5-C20 aryl or heteroaryl group, wherein the above radicals may in turn be substituted by halogen, —OH, —CN, and
x is an integer 1, 2, 3, 4, 5, 6, 7, 8, 9 or 10
y is an integer 1, 2, 3, 4, 5, 6, 7, 8, 9 or 10
   and/or of the formula 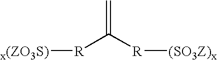
   in which
R is a bond, a divalent C1-C15 alkylene group, a divalent C1-C15 alkylenoxy group, for example an ethylenoxy group, or a divalent C5-C20 aryl or heteroaryl group, wherein the above radicals may in turn be substituted by halogen, —OH, COOZ, —CN, NZ₂,
Z independently of one another is hydrogen, a C1-C15 alkyl group, a C1-C15 alkoxy group, an ethylenoxy group or a C5-C20 aryl or heteroaryl group, wherein the above radicals may in turn be substituted by halogen, —OH, —CN, and
x is an integer 1, 2, 3, 4, 5, 6, 7, 8, 9 or 10
   and/or of the formula 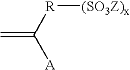
   in which
A is a group of the formula COOR², CN, CONR²₂, OR² and/or R², in which R² is hydrogen, a C1-C15 alkyl group, a C1-C15 alkoxy group, an ethylenoxy group or a C5-C20 aryl or heteroaryl group, wherein the above radicals may in turn be substituted by halogen, —OH, COOZ, —CN, NZ₂
R is a bond, a divalent C1-C15 alkylene group, a divalent C1-C15 alkylenoxy group, for example an ethylenoxy group, or a divalent C5-C20 aryl or heteroaryl group, wherein the above radicals may in turn be substituted by halogen, —OH, COOZ, —CN, NZ₂,
Z independently of one another is hydrogen, a C1-C15 alkyl group, a C1-C15 alkoxy group, an ethylenoxy group or a C5-C20 aryl or heteroaryl group, wherein the above radicals may in turn be substituted by halogen, —OH, —CN, and
x is an integer 1, 2, 3, 4, 5, 6, 7, 8, 9 or 10.

The preferred monomers containing sulphonic acid groups include, inter alia, alkenes which contain sulphonic acid groups, such as ethenesulphonic acid, propenesulphonic acid, butenesulphonic acid; acrylic acid compounds and/or methacrylic acid compounds which contain sulphonic acid groups, such as for example 2-sulphonomethylacrylic acid, 2-sulphonomethylmethacrylic acid, 2-sulphonomethylacrylic acid amide and 2-sulphonomethylmethacrylic acid amide.

With particular preference, use is made of commercially available vinylsulphonic acid (ethenesulphonic acid), as obtainable for example from Aldrich or Clariant GmbH. A preferred vinylsulphonic acid has a purity of more than 70%, in particular 90% and particularly preferably more than 97% purity.

The monomers containing sulphonic acid groups may also be used in the form of derivatives which can subsequently be converted into the acid, wherein the conversion to acid may also take place in the polymerised state. These derivatives include in particular the salts, esters, amides and halides of the monomers containing sulphonic acid groups.

According to one particular aspect of the present invention, the weight ratio of monomers containing sulphonic acid groups to monomers containing phosphonic acid groups may lie in the range from 100:1 to 1:100, preferably 10:1 to 1:10 and particularly preferably 2:1 to 1:2.

According to a further particular aspect of the present invention, monomers containing phosphonic acid groups are preferred over monomers containing sulphonic acid groups. Accordingly, use is particularly preferably made of a liquid which contains monomers containing phosphonic acid groups.

In a further embodiment of the invention, monomers capable of crosslinking can be used in the production of the polymer membrane. These monomers may be added to the liquid used to treat the film. The monomers capable of crosslinking may also be applied to the flat structure after treatment with the liquid.

The monomers capable of crosslinking are in particular compounds which contain at least 2 carbon-carbon double bonds. Preference is given to dienes, trienes, tetraenes, dimethylacrylates, trimethylacrylates, tetramethylacrylates, diacrylates, triacrylates, tetraacrylates.

Particular preference is given to dienes, trienes, tetraenes of the formula 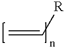
dimethylacrylates, trimethylacrylates, tetramethylacrylates of the formula 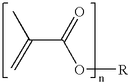
diacrylates, triacrylates, tetraacrylates of the formula 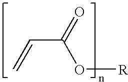
in which
R is a C1-C15 alkyl group, a C5-C20 aryl or heteroaryl group, NR′, —SO₂, PR′, Si(R′)₂, wherein the above radicals may in turn be substituted,
R′ independently of one another are hydrogen, a C1-C15 alkyl group, a C1-C15 alkoxy group, a C5-C20 aryl or heteroaryl group, and
n is at least 2.

The substituents of the above radical R are preferably halogen, hydroxyl, carboxy, carboxyl, carboxyl ester, nitrile, amine, silyl or siloxane radicals.

Particularly preferred crosslinkers are allyl methacrylate, ethylene glycol dimethacrylate, diethylene glycol dimethacrylate, triethylene glycol dimethacrylate, tetraethylene glycol dimethacrylate and polyethylene glycol dimethacrylate, 1,3-butanediol dimethacrylate, glycerol dimethacrylate, diurethane dimethacrylate, trimethylpropane trimethacrylate, epoxy acrylates, for example ebacryl, N′,N-methylenebisacrylamide, carbinol, butadiene, isoprene, chloroprene, divinylbenzene and/or bisphenol-A-dimethylacrylate. These compounds are commercially available for example from Sartomer Company Exton, Pa. under the names CN-120, CN104 and CN-980.

The use of crosslinkers is optional, wherein these compounds can usually be used in the range between 0.05 to 30% by weight, preferably 0.1 to 20% by weight, particularly preferably 1 to 10% by weight, based on the weight of the monomers containing phosphonic acid groups.

The liquid which contains monomers containing phosphonic acid groups and/or monomers containing sulphonic acid groups may be a solution, wherein the liquid may also contain suspended and/or dispersed constituents. The viscosity of the liquid which contains monomers containing phosphonic acid groups and/or monomers containing sulphonic acid groups may lie within wide ranges, wherein it is possible to add solvents or to increase the temperature in order to adjust the viscosity. The dynamic viscosity preferably lies in the range from 0.1 to 10,000 mPa*s, in particular 0.2 to 2000 mPa*s, wherein these values can be measured for example according to DIN 53015.

According to one preferred embodiment of the present method, a polymer-comprising shaped body is passed through a liquid-filled trough at least twice, wherein the polymer-comprising shaped body is unwound from one reel and wound onto another reel and the running direction of the polymer-comprising shaped body alternates during the treatment by changing the direction of rotation of the reels.

The shaped body, for example a film, is passed through a liquid bath at least twice, preferably at least 10 times and particularly preferably at least 25 times, wherein the running direction of the film is alternated by changing the direction of rotation of the reels.

The speed at which the shaped body is passed through the liquid depends on the type of liquid and the type of shaped body. In general, the shaped body is drawn through the liquid bath at a speed of 0.5 to 100 m/min, in particular 1.0 to 25 m/min.

The extent to which the shaped body dips into the liquid is preferably 0.05 to 10 m, in particular 0.15 m to 2 m.

According to one particular embodiment of the present method, the total treatment time lies in the range from 2 minutes to 10 hours, preferably in the range from 15 minutes to 3 hours.

The speed at which the shaped body is passed through the liquid bath can be controlled in a manner known per se. This includes inter alia controlling the speed of rotation of the reels via a tachoroller or by measuring their rotational speed.

According to one particular embodiment of the present invention, the shaped body is subjected to a drawback force during the treatment. As a result, it is possible for example to wind up a film in a particularly uniform, smooth and fold-free manner. Furthermore, the pore size and the anisotropy of the shaped body can be influenced as a result. A shaped body is preferably treated with a drawback force in the range from 0.1 to 400 N, in particular 0.2 to 300 N and particularly preferably 2.4 to 120 N, without this being intended to represent any limitation.

With preference, a film is passed through the liquid-filled trough with a drawback force based on the width of the film in the range from 0.5 to 200 N/m, preferably 1 to 150 N/m and particularly preferably in the range from 12 to 60 N/m. The width here refers to the length dimension of the film perpendicular to the running direction prior to the treatment with liquid. Based on a film with a width in the range from 20 cm to 200 cm, this results in preferred drawback forces in the range from 0.1 to 400 N, in particular 0.2 to 300 N and particularly preferably 2.4 to 120 N, without this being intended to represent any limitation.

According to one particular aspect of the present invention, liquid adheres to the film, wherein preferably at least 1 g/m², in particular at least 10 g/m² of liquid remains on the film after treatment. This value relates to the increase in weight as a result of the treatment with liquid, with respect to the weight of a dry film which has been freed from solvent residues by means of at least one washing step.

During the treatment of the film with a washing liquid, for example water, preferably 1 to 1000 ml/m², in particular 5 to 250 ml/m², particularly preferably 15 to 150 ml/m² and very particularly preferably 25 to 75 ml/m² adhere to the film. Excess liquid can optionally be removed for example by means of a roller.

If the film is doped with monomers containing phosphonic acid groups and/or monomers containing sulphonic acid groups, preferably 1 to 1000 ml/m², in particular 10 to 800 ml/m², particularly preferably 50 to 600 ml/m² and very particularly preferably 100 to 400 ml/m² adhere to the film.

The amount of liquid which adheres to the film and penetrates into the latter after treatment in the liquid bath can be controlled by way of the speed at which the film is passed through the liquid bath.

The amount of liquid is also dependent on the temperature at which the treatment takes place. The temperature at which the present method is carried out is not critical and can therefore fluctuate within wide ranges, with polymerisation of the monomers in the trough generally being avoided. In general, however, the present method is preferably carried out in the range from 0 to 150° C., preferably 10° C. to 100° C., wherein the ranges depend on the physical properties of the liquid.

According to one particular embodiment, the liquid located in the trough can be renewed as necessary or replaced by another liquid. By way of example, a soiled liquid may be replaced by a fresh liquid of the same type. The liquid may also be replaced by a different liquid. By virtue of this measure, a film can be both washed and doped without having to use a different device. This procedure may take place in batches or continuously, wherein it is also possible for individual components to be metered in.

According to one particular embodiment, the liquid in the trough may be circulated in order to ensure the homogeneity of the liquid, so that for example a change in composition is avoided.

Jiggers are particularly suitable for carrying out the present method, these jiggers being described for example in Dietmar Fries, Ausbildungsmittel, Unterrichtshilfen “Textilveredelung, Beschichten”, Arbeitgeberkreis Gesamttextil AGK (1992) page 2.13. These devices can be obtained commercially inter alia from Mathis AG and Kuester AG.

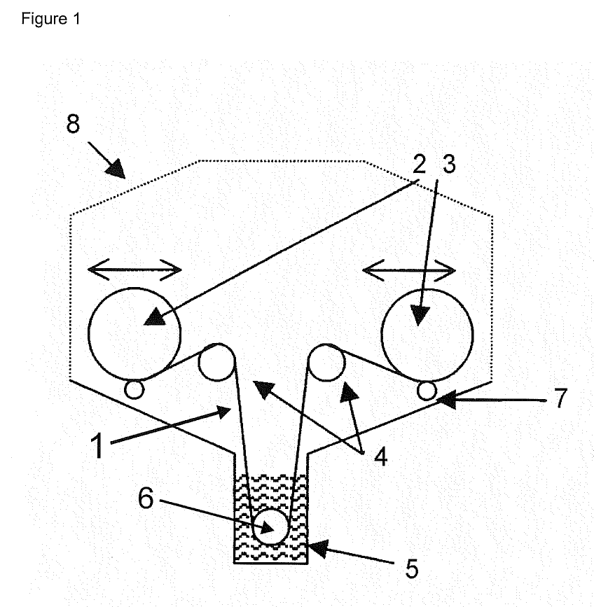

Hereinbelow, the present invention will be illustrated using a jigger shown schematically in FIG. 1, without this description being intended to limit the invention.

A polymer film (1), for example a polyazole film, is unwound from a reel (2) and wound onto a second reel (3) and in the process is passed for example over a roller (4). The film is passed through a trough (5) and is deflected there over a roller (6). In the trough, the film is treated with liquid. After leaving the trough, followed by a further deflection, excess liquid may optionally be removed by pressure, which is generated via a further roller (7), before winding up. Liquid usually adheres to the polyazole films, so that this liquid also acts on the film in the wound-up state.

All parts of the jigger which come into contact with the liquid may be provided with a rust-proof coating. With particular preference, use may be made of jiggers whose parts, such as rollers, reels, etc., are coated with stable plastics, for example perfluorinated polymers, polyetherketone and polyethersulphone, in particular ®Etlon. This is advantageous in particular for doping the film with concentrated acids. Accordingly, the rollers and reels may for example be made of stainless steel.

The speed and/or drawback force of the film can be determined for example by way of the rollers (4) and/or (6), which is then designed as a tachoroller or tensiometer roller. The device may also be provided with an electronic control system which controls the speed and the running direction of the rollers. For instance, it may be provided that the device automatically alternates the running direction once the entire film (1) has been transferred from one reel (2) to the second reel (3).

Means for controlling the temperature of the jigger, in particular of the trough (5), may also be provided, wherein the thermal energy input into the wound-up film also depends in particular on the rotational speed of the reels (2) and (3).

The jigger may also comprise a cover (8) which closes off the trough and the reels from the surrounding environment. As a result, evaporation of the liquid can be prevented. Hygroscopic liquids, such as concentrated phosphoric acid for example, can also be protected from moisture, with it being possible for the jigger to be rinsed with dry air or with nitrogen.

In order to further improve the technical properties, it is also possible for fillers, in particular proton-conducting fillers, and additional acids to be added to the membrane. Such substances preferably have an intrinsic conductivity at 100° C. of at least 10⁻⁶ S/cm, in particular 10⁻⁵ S/cm. The addition may take place for example by adding these to the liquid which contains the monomers containing phosphonic acid groups and/or monomers containing sulphonic acid groups. These additives, if they are in liquid form, may also be added after polymerisation of the monomers.

Non-limiting examples of proton-conducting fillers are
sulphates such as: CsHSO₄, Fe(SO₄)₂, (NH₄)₃H(SO₄)₂, LiHSO₄, NaHSO₄, KHSO₄, RbSO₄, LiN₂H₅SO₄, NH₄HSO₄,
phosphates such as Zr₃(PO₄)₄, Zr(HPO₄)₂, HZr₂(PO₄)₃, UO₂PO₄.3H₂O, H₈UO₂PO₄, Ce(HPO₄)₂, Ti(HPO₄)₂, KH₂PO₄, NaH₂PO₄, LiH₂PO₄, NH₄H₂PO₄, CsH₂PO₄, CaHPO₄, MgHPO₄, HSbP₂O₈, HSb₃P₂O₁₄, H₅Sb₅P₂O₂₀,
polyacids such as H₃PW₁₂O₄₀.nH₂O (n=21-29), H₃SiW₁₂O₄₀.nH₂O (n=21-29), HₓWO₃, HSbWO₆, H₃PMo₁₂O₄₀, H₂Sb₄O₁₁, HTaWO₆, HNbO₃, HTiNbO₅, HTiTaO₅, HSbTeO₆, H₅Ti₄O₉, HSbO₃, H₂MoO₄
selenides and arsenides such as (NH₄)₃H(SeO₄)₂, UO₂AsO₄, (NH₄)₃H(SeO₄)₂, KH₂AsO₄, Cs₃H(SeO₄)₂, Rb₃H(SeO₄)₂,
phosphides such as ZrP, TiP, HfP
oxides such as Al₂O₃, Sb₂O₅, ThO₂, SnO₂, ZrO₂, MoO₃
silicates such as zeolites, phyllosilicates, tectosilicates, H-natrolites, H-mordenites, NH₄-analcines, NH₄-sodalites, NH₄-gallates, H-montmorillonites
acids such as HClO₄, SbF₅
fillers such as carbides, in particular SiC, Si₃N₄, fibres, in particular glass fibres, glass powders and/or polymer fibres, preferably based on polyazoles.

These additives may be contained in the proton-conducting polymer membrane in customary amounts, although the positive properties, such as high conductivity, long life span and high mechanical stability of the membrane must not be too greatly impaired by adding excessively large amounts of additive. In general, the membrane after polymerisation comprises at most 80% by weight, preferably at most 50% by weight and particularly preferably at most 20% by weight of additives.

In addition, this membrane may also contain perfluorinated sulphonic acid additives (preferably 0.1-20% by weight, more preferably 0.2-15% by weight, very preferably 0.2-10% by weight). These additives lead to an improvement in performance, to an increase in the oxygen solubility and oxygen diffusion close to the cathode and to a reduction in the adsorption of phosphoric acid and phosphate on platinum. (Electrolyte additives for phosphoric acid fuel cells. Gang, Xiao; Hjuler, H. A.; Olsen, C.; Berg, R. W.; Bjerrum, N. J. Chem. Dep. A, Tech. Univ. Denmark, Lyngby, Den. J. Electrochem. Soc. (1993), 140(4), 896-902 and Perfluorosulfonimide as an additive in phosphoric acid fuel cell. Razaq, M.; Razaq, A.; Yeager, E.; DesMarteau, Darryl D.; Singh, S. Case Cent. Electrochem. Sci., Case West. Reserve Univ., Cleveland, Ohio, USA. J. Electrochem. Soc. (1989), 136(2), 385-90). Non-limiting examples of perfluorinated sulphonic acid additives are: trifluoromethanesulphonic acid, potassium trifluoromethanesulphonate, sodium trifluoromethanesulphonate, lithium trifluoromethanesulphonate, ammonium trifluoromethanesulphonate, potassium perfluorohexanesulphonate, sodium perfluorohexanesulphonate, lithium perfluorohexanesulphonate, ammonium perfluorohexanesulphonate, perfluorohexanesulphonic acid, potassium nonafluorobutanesulphonate, sodium nonafluorobutanesulphonate, lithium nonafluorobutanesulphonate, ammonium nonafluorobutanesulphonate, caesium nonafluorobutanesulphonate, triethylammonium perfluorohexanesulphonate and perfluorosulphonimides.

After treatment of the film with a liquid which contains monomers containing phosphonic acid groups and/or monomers containing sulphonic acid groups, the monomers contained in the film can be polymerised.

The polymerisation of the monomers containing phosphonic acid groups preferably takes place via the free-radical route. Free-radical formation may take place thermally, photochemically, chemically and/or electrochemically.

By way of example, a starter solution can be applied after the treatment with the liquid which contains monomers containing phosphonic acid groups and/or monomers containing sulphonic acid groups. This may take place by means of measures known per se (e.g. spraying, dipping, etc.) which are known from the prior art. It is also possible to add a starter solution to the liquid which contains monomers containing phosphonic acid groups and/or monomers containing sulphonic acid groups.

Suitable free-radical generators are, inter alia, azo compounds, peroxy compounds, persulphate compounds or azoamidines. Non-limiting examples are dibenzoyl peroxide, dicumene peroxide, cumene hydroperoxide, diisopropyl peroxydicarbonate, bis(4-t-butylcyclohexyl)peroxydicarbonate, dipotassium persulphate, ammonium peroxydisulphate, 2,2′-azobis(2-methylpropionitrile) (AIBN), 2,2′-azobis(isobutyric acid amidine)hydrochloride, benzopinacol, dibenzyl derivatives, methyl ethylene ketone peroxide, 1,1-azobiscyclohexanecarbonitrile, methyl ethyl ketone peroxide, acetyl acetone peroxide, dilauryl peroxide, didecanoyl peroxide, tert.-butylper-2-ethyl hexanoate, ketone peroxide, methyl isobutyl ketone peroxide, cyclohexanone peroxide, dibenzoyl peroxide, tert.-butylperoxybenzoate, tert.-butylperoxyisopropylcarbonate, 2,5-bis(2-ethylhexanoylperoxy)-2,5-dimethylhexane, tert.-butylperoxy-2-ethylhexanoate, tert.-butylperoxy-3,5,5-trimethylhexanoate, tert.-butylperoxyisobutyrate, tert.-butylperoxyacetate, dicumene peroxide, 1,1-bis(tert.-butylperoxy)cyclohexane, 1,1-bis(tert.-butylperoxy)-3,3,5-trimethylcyclohexane, cumyl hydroperoxide, tert.-butylhydroperoxide, bis(4-tert.-butylcyclohexyl)peroxydicarbonate, and the free-radical generators available from DuPont under the name ®Vazo, for example ®Vazo V50 and ®Vazo WS.

Use may also be made of free-radical generators which form free radicals when exposed to radiation. The preferred compounds include inter alia α,α-diethoxyacetophenone (DEAP, Upjon Corp), n-butyl benzoin ether (®Trigonal-14, AKZO) and 2,2-dimethoxy-2-phenylacetophenone (®Igacure 651) and 1-benzoylcyclohexanol (®Igacure 184), bis(2,4,6-trimethylbenzoyl)-phenylphosphine oxide (®Irgacure 819) and 1-[4-(2-hydroxyethoxy)phenyl]-2-hydroxy-2-phenylpropan-1-one (®Irgacure 2959), which are in each case commercially available from Ciba Geigy Corp.

Usually between 0.0001 and 5% by weight, in particular 0.01 to 3% by weight (based on the weight of monomers containing phosphonic acid groups) of free-radical generators are added. The amount of free-radical generators can be varied depending on the required degree of polymerisation.

The polymerisation may also take place by exposure to IR or NIR (IR=infrared, i.e. light with a wavelength of more than 700 nm; NIR=near-IR, i.e. light with a wavelength in the range from approx. 700 to 2000 nm or an energy in the range from approx. 0.6 to 1.75 eV). In this case, it is also possible for a moist film to be irradiated. In addition to polymerisation, the irradiation also brings about drying.

The polymerisation may also take place by exposure to UV light with a wavelength of less than 400 nm. This polymerisation method is known per se and is described for example in Hans Joerg Elias, Makromolekulare Chemie, 5th edition, vol. 1, pages 492-511; D. R. Arnold, N. C. Baird, J. R. Bolton, J. C. D. Brand, P. W. M Jacobs, P. de Mayo, W. R. Ware, Photochemistry-An Introduction, Academic Press, New York and M. K. Mishra, Radical Photopolymerization of Vinyl Monomers, J. Macromol. Sci.-Revs. Macromol. Chem. Phys. C22(1982-1983) 409.

The polymerisation may also take place by exposure to β rays, γ rays and/or electron rays. According to one particular embodiment of the present invention, a membrane is irradiated with a radiation dose in the range from 1 to 300 kGy, preferably 3 to 250 kGy and very particularly preferably 20 to 200 kGy.

The polymerisation of the monomers containing phosphonic acid groups preferably takes place at temperatures above room temperature (20° C.) and below 200° C., in particular at temperatures between 40° C. and 150° C., particularly preferably between 50° C. and 120° C. The polymerisation preferably takes place at normal pressure, but may also take place under pressure. The polymerisation leads to a hardening of the flat structure, wherein this hardening can be monitored by means of microhardness measurement. The increase in hardness brought about by the polymerisation is preferably at least 20%, based on the hardness of the membrane prior to polymerisation.

According to one particular embodiment of the present invention, the membranes have a high mechanical stability. This value is obtained from the hardness of the membrane, which is determined by means of microhardness measurement according to DIN 50539. To this end, the membrane is successively subjected to a force of up to 3 mN by a Vickers diamond over 20 s, and the penetration depth is determined. Accordingly, the hardness at room temperature is at least 0.01 N/mm², preferably at least 0.1 N/mm² and very particularly preferably at least 1 N/mm², without this being intended to represent any limitation. The force is then kept constant at 3 mN for 5 s and the creep is calculated from the penetration depth. In preferred membranes, the creep C_{HU} 0.003/20/5 under these conditions is less than 20%, preferably less than 10% and very particularly preferably less than 5%. The modulus determined by means of microhardness measurement is YHU at least 0.5 MPa, in particular at least 5 MPa and very particularly preferably at least 10 MPa, without this being intended to represent any limitation.

Depending on the desired degree of polymerisation, the flat structure which is obtained after polymerisation is a self-supporting membrane. Preferably, the degree of polymerisation is at least 2, in particular at least 5, particularly preferably at least 30 repeating units, in particular at least 50 repeating units, very particularly preferably at least 100 repeating units. This degree of polymerisation is determined via the number-average molecular weight Mₙ, which can be determined by means of GPC methods. Due to the problems with regard to isolating without any degradation the polymers containing phosphonic acid groups that are contained in the membrane, this value is determined using a sample which is carried out by polymerisation of monomers containing phosphonic acid groups and/or monomers containing sulphonic acid groups, without any addition of polymer. Here, the proportion by weight of monomer containing phosphonic acid groups and of free-radical initiators is kept constant in comparison to the conditions under which the membrane is produced. The conversion achieved in a comparative polymerisation is preferably greater than or equal to 20%, in particular greater than or equal to 40% and particularly preferably greater than or equal to 75%, based on the monomers containing phosphonic acid groups which are used.

The polymers containing phosphonic acid groups that are contained in the membrane preferably have a broad molecular weight distribution. For example, the polymers containing phosphonic acid groups may have a polydispersity M_{w}/Mₙ in the range from 1 to 20, particularly preferably 3 to 10.

The water content of the proton-conducting membrane is preferably at most 15% by weight, particularly preferably at most 10% by weight and very particularly preferably at most 5% by weight.

In this connection, it may be assumed that the conductivity of the membrane may be based on the Grotthus mechanism, as a result of which the system does not require any additional wetting. Accordingly, preferred membranes contain proportions of low-molecular-weight polymers containing phosphonic acid groups. For example, with a degree of polymerisation in the range from 2 to 20, the proportion of polymers containing phosphonic acid groups may be preferably at least 10% by weight, particularly preferably 20% by weight, based on the weight of the polymers containing phosphonic acid groups.

The polymerisation may lead to a decrease in the layer thickness. Preferably, the thickness of the self-supporting membrane is between 15 and 1000 μm, preferably between 20 and 500 μm, in particular between 30 and 250 μm.

After a first polymerisation of the monomers introduced into the polymer film in a first step, the resulting film may again be treated with a liquid which contains monomers containing phosphonic acid groups and/or monomers containing sulphonic acid groups. As a result, the content of polymers containing phosphonic acid groups in the film can be increased. In this connection, it should be noted that the stability of the film decreases by doping the film with monomers containing phosphonic acid groups and/or monomers containing sulphonic acid groups. However, the stability of the film must not fall below a certain value, which depends on the device used. However, the polymerisation of the monomers increases the stability of the film, so that the doping process can be repeated in order for example to increase the content of phosphonic acid groups in the polymer membrane.

According to one particular aspect of the present invention, a combination of the treatment step with the liquid which contains monomers containing phosphonic acid groups and/or monomers containing sulphonic acid groups and subsequent polymerisation of the monomers can be carried out at least twice, preferably at least 4 times and particularly preferably at least 6 times.

Following the polymerisation, the membrane may be thermally, photochemically, chemically and/or electrochemically crosslinked at the surface. This hardening of the membrane surface further improves the properties of the membrane.

According to one particular aspect, the membrane may be heated to a temperature of at least 150° C., preferably at least 200° C. and particularly preferably at least 250° C. The thermal crosslinking preferably takes place in the presence of oxygen. The oxygen concentration in this method step usually lies in the range from 5 to 50% by volume, preferably 10 to 40% by volume, without this being intended to represent any limitation.

The crosslinking may also take place by exposure to IR or NIR (IR=infrared, i.e. light with a wavelength of more than 700 nm; NIR=near-IR, i.e. light with a wavelength in the range from approx. 700 to 2000 nm or an energy in the range from approx. 0.6 to 1.75 eV) and/or UV light. Another method is exposure to β rays, γ rays and/or electron rays. The radiation dose here is preferably between 5 and 250 kGy, in particular 10 to 200 kGy. The irradiation may take place in air or under inert gas. As a result, the use properties of the membrane are improved, particularly the durability thereof.

Depending on the desired degree of crosslinking, the duration of the crosslinking reaction may lie within a wide range. In general, this reaction time lies in the range from 1 second to 10 hours, preferably 1 minute to 1 hour, without this being intended to represent any limitation.

According to one particular embodiment of the present invention, the membrane comprises at least 3% by weight, preferably at least 5% by weight and particularly preferably at least 7% by weight of phosphorus (as an element), based on the total weight of the membrane. The proportion of phosphorus can be determined by elemental analysis. For this, the membrane is dried at 110° C. for 3 hours in a vacuum (1 mbar).

The polymer containing phosphonic acid groups preferably has a content of phosphonic acid groups of at least 5 meq/g, particularly preferably at least 10 meq/g. This value is determined by way of the so-called ion exchange capacity (IEC).

In order to measure the IEC, the phosphonic acid groups are converted into the free acid, with the measurement taking place prior to polymerisation of the monomers containing phosphonic acid groups. The sample is then titrated with 0.1 M NaOH. The ion exchange capacity (IEC) is then calculated from the consumption of acid up to the equivalent point and the dry weight.

The polymer membrane obtainable by the present method has improved material properties compared to the previously known doped polymer membranes. In particular, they exhibit better performance than known doped polymer membranes. This is due in particular to an improved intrinsic proton conductivity, which is due in particular to the presence of polymers containing phosphonic acid groups. At temperatures of 120° C., this conductivity is at least 1 mS/cm, preferably at least 2 mS/cm, in particular at least 5 mS/cm.

What is more, the membranes exhibit high conductivity even at a temperature of 70° C. The conductivity is dependent inter alia on the content of sulphonic acid groups in the membrane. The higher this proportion, the better the conductivity at low temperatures. Here, a membrane may be wetted at low temperatures. To this end, the compound used as energy source, for example hydrogen, may be provided with a proportion of water. In many cases, however, the water formed by the reaction is sufficient to achieve wetting.

The specific conductivity is measured by means of impedance spectroscopy in a 4-pole arrangement in potentiostatic mode and using platinum electrodes (wire, 0.25 mm diameter). The gap between the current-collecting electrodes is 2 cm. The spectrum obtained is evaluated using a simple model consisting of a parallel arrangement of an ohmic resistor and a capacitor. The cross section of the sample of the phosphoric-acid-doped membrane is measured immediately prior to mounting of the sample. In order to measure the temperature-dependence, the measurement cell is brought to the desired temperature in an oven, said temperature being controlled by a Pt-100 thermocouple positioned in the direct vicinity of the sample. Once the temperature is reached, the sample is held at this temperature for 10 minutes prior to the start of measurement.

The crossover current density during operation with 0.5 M methanol solution and at 90° C. in a so-called liquid direct methanol fuel cell is preferably less than 100 mA/cm², in particular less than 70 mA/cm², particularly preferably less than 50 mA/cm² and very particularly preferably less than 10 mA/cm². The crossover current density during operation with a 2 M methanol solution and at 160° C. in a so-called gaseous direct methanol fuel cell is preferably less than 100 mA/cm², in particular less than 50 mA/cm², very particularly preferably less than 10 mA/cm².

In order to determine the crossover current density, the amount of carbon dioxide released at the cathode is measured by means of a CO₂ sensor. The crossover current density is calculated from the value obtained in this way for the amount of CO₂, as described by P. Zelenay, S. C. Thomas, S. Gottesfeld in S. Gottesfeld, T. F. Fuller “Proton Conducting Membrane Fuel Cells II” ECS Proc., vol. 98-27, pages 300-308.

Possible fields of use of the intrinsically conductive polymer membranes include inter alia uses in fuel cells, in electrolysis, in capacitors and in battery systems. On account of their property profile, the polymer membranes can preferably be used in fuel cells, in particular in direct methanol fuel cells.

Preferred anisotropic shaped bodies are also membranes which can be used for example for microfiltration, ultrafiltration, reverse osmosis, electrodialysis and pervaporation. These shaped bodies are obtainable in particular by removing the monomers containing phosphonic acid groups after the treatment with the liquid. This may be achieved for example by washing with the previously mentioned washing liquids.

The shape of some of the pores of preferred membranes is anisotropic. Accordingly, the pores do not have a round shape, but rather a shape which has a different dimension in terms of height and width. The width of these pores preferably lies in the range from 1.5 nm to 700 nm, in particular in the range from 8 nm to 400 nm and particularly preferably 15 nm to 200 nm. The height of these pores lies preferably in the range from 1 nm to 500 nm, in particular in the range from 5 nm to 300 nm and particularly preferably 10 nm to 150 nm. When considered two-dimensionally, the width here is understood as the largest longitudinal dimension of the pores and the height is understood as the minimum longitudinal dimension of the pores. The ratio of width to height preferably lies in the range from 1.2 to 20, in particular in the range from 1.5 to 10 and particularly preferably in the range from 2 to 5. These values can be determined in particular by means of transmission electron microscopy (TEM) or atomic force microscopy (AFM).

According to one particular aspect of the present invention, preferably at least 70%, particularly preferably at least 80% of the pores have an anisotropic shape.

An anisotropic shaped body of the present invention, for example a membrane for microfiltration, ultrafiltration, etc. or a proton-conducting polymer electrolyte membrane which can be used in particular in fuel cells, preferably has a maximum modulus of elasticity of at least 50 MPa, in particular at least 100 MPa and particularly preferably at least 150 MPa. The ratio of maximum modulus of elasticity to minimum modulus of elasticity is preferably at least 1.5, in particular at least 1.8 and particularly preferably at least 2.1. The maximum modulus of elasticity is generally obtained from the value which is measured in the load direction, whereas the minimum value results from the value perpendicular to the load direction. The load direction refers to the direction in which the tension is exerted during the process of winding up onto a reel according to the present method. The modulus of elasticity can be determined by tensile tests, as described in German patent application no. 10129458.1.

The invention will be explained in more detail below on the basis of examples, without this being intended to represent any limitation.

A PBI film having a length of 10 m, a width of 36 cm and a thickness of 55 μm, which was produced as described in German patent application no. 10331365.6, was introduced into a trough filled with 5 l of 90% strength aqueous vinylphosphonic acid (VPA) at 70° C. The film was fed from a reel at a speed of 3 m/min and subjected to a drawback force of 0.63 N/cm and wound onto another reel. The running direction of the PBI film was alternated during the treatment by changing the direction of rotation of the reels. The film was doped for a total of 3 h. The thickness of the film after doping was 105 μm. The doped film was then irradiated with a radiation dose of 99 kJ/kg.

TABLE 1
Properties at RT (23° C.)

| | Longitudinal direction | Transverse direction |
|---|---|---|
| Modulus of elasticity [MPa] | 224 | 98 |
| Break strength [kJ/mm²] | 524 | 624 |
| Elongation at break [%] | 51 | 118 |

1. A method for producing anisotropic shaped bodies comprising the steps of:
providing a liquid contained in a trough;
providing a first reel where a polymer-comprising shaped body is wound around said first reel;
providing a second reel;
unwinding said polymer-comprising shaped body from said first reel;
passing said polymer-comprising shaped body through said liquid;
winding said polymer-comprising shaped body onto said second reel;
wherein said liquid contains monomers;
wherein said monomers are selected from the group containing phosphonic acid groups, sulphonic acid groups, or combinations thereof.

2. The method according to claim 1, characterized in that said polymer-comprising shaped body is passed through said liquid at least twice;
wherein said polymer-comprising shaped body is unwound from one reel and wound onto another reel and the running direction of said polymer-comprising shaped body alternates while passing through said liquid by changing the direction of rotation of said reels.

3. The method according to claim 1, characterized in that said polymer-comprising shaped body is a polymer film.

4. The method according to claim 1, characterized in that said liquid contains at least 50% by weight of monomers containing phosphonic acid groups, based on the total weight of the liquid.

5. The method according to claim 1, characterized in that said polymer-comprising shaped body is comprised of polyazoles.

6. The method according to claim 5, characterized in that said polymer-comprising shaped body comprised of at least 80% by weight of polyazoles.

7. The method according to claim 3, characterized in that liquid adheres to said polymer film after passing through said liquid.

8. The method according to claim 7, characterized in that at least 1 g/m² of liquid adheres to said polymer film.

9. The method according to claim 3 where said liquid comprises at least 70% by weight of water and further comprises the step of;
providing a second liquid in a second trough where said second liquid contains monomers, wherein said monomers are selected from the group consisting of phosphonic acid groups, sulphonic acid groups, or combinations thereof;
passing said polymer film through said liquid comprising at least 70% by weight of water; and
passing said polymer film through said second liquid containing less than 70% by weight of water.

10. The method according to claim 2, characterized in that said polymer-comprising shaped body is passed through said liquid at least 10 times.

11. The method according to claim 1, characterized in that said polymer-comprising shaped body is passed through said liquid at a speed of 0.5 to 100 m/min.

12. The method according to claim 1, characterized in that said polymer-comprising shaped body is passed through with a drawback force based on the width of said polymer film in the range from 0.5 to 200 N/m.

13. The method according to claim 1, characterized in that said polymer film is treated for 15 minutes to 3 hours.

14. The method according to claim 1, where said liquid contains at least one monomer containing phosphonic acid groups, of a formula where said formula is selected from the group consisting of: 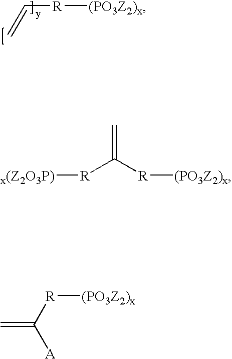
, or combinations thereof;
where R is a radical being selected from the group consisting of: a bond, a divalent C1-C15 alkylene group, a divalent C1-C15 alkylenoxy group, a divalent C5-C20 aryl group, a divalent C5-C20 heteroaryl group, or combinations thereof; wherein the above said radicals may in turn be substituted by halogen, —OH, COOZ, —CN, NZ₂;
where Z, independently of one another, is a radical being selected from the group consisting of: a hydrogen, a C1-C15 alkyl group, a C1-C15 alkoxy group, an ethylenoxy group, a C5-C20 aryl group, a C5-C20 heteroaryl group, or combinations thereof; wherein the above said radicals may in turn be substituted by halogen, —OH, —CN;
where A is a group being selected from the group consisting of: COOR², CN, CONR²₂, OR² R², or combinations thereof;
where R² is a double radical being selected from the group consisting of: a hydrogen, a C1-C15 alkyl group, a C1-C15 alkoxy group, an ethylenoxy group or a C5-C20 aryl or heteroaryl group; wherein the above radicals may in turn be substituted by halogen, —OH, COOZ, —CN, NZ₂;
x is an integer 1, 2, 3, 4, 5, 6, 7, 8, 9 or 10; and
y is an integer 1, 2, 3, 4, 5, 6, 7, 8, 9 or 10.

15. The method according to claim 1, where said liquid contains at least one monomer containing sulphonic acid groups, of a formula where said formula is selected from the group consisting of: 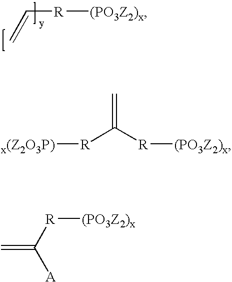
, or combinations thereof;
where R is a radical being selected from the group consisting of: a bond, a divalent C1-C15 alkylene group, a divalent C1-C15 alkylenoxy group, a divalent C5-C20 aryl group, a divalent C5-C20 heteroaryl group, or combinations thereof; wherein the above said radicals may in turn be substituted by halogen, —OH, COOZ, —CN, NZ₂;
where Z, independently of one another, is a radical being selected from the group consisting of: a hydrogen, a C1-C15 alkyl group, a C1-C15 alkoxy group, an ethylenoxy group, a C5-C20 aryl group, a C5-C20 heteroaryl group, or combinations thereof; wherein the above said radicals may in turn be substituted by halogen, —OH, —CN;
where A is a group being selected from the group consisting of: COOR², CN, CONR²₂, OR² R², or combinations thereof;
where R² is a double radical being selected from the group consisting of: a hydrogen, a C1-C15 alkyl group, a C1-C15 alkoxy group, an ethylenoxy group or a C5-C20 aryl or heteroaryl group, wherein the above radicals may in turn be substituted by halogen, —OH, COOZ, —CN, NZ₂;
x is an integer 1, 2, 3, 4, 5, 6, 7, 8, 9 or 10; and
y is an integer 1, 2, 3, 4, 5, 6, 7, 8, 9 or 10.

16. The method according to claim 1, characterized in that said liquid comprises at least one monomer which is capable of crosslinking and which contains at least 2 carbon-carbon double bonds.

17. The method according to claim 1, characterized in that said liquid contains at least one polymer selected from the group consisting of a dispersed polymer a suspended polymer, or combinations thereof.

18. The method according to claim 1, characterized in that the monomers containing phosphonic acid groups, which are obtained after treatment with said liquid in the resulting proton-conducting electrolyte membrane, are polymerised.

19. The method according to claim 18, characterized in that, after said polymerisation, the resulting membrane is again treated with a liquid which contains monomers;
wherein said monomers are selected from the group consisting of monomers containing phosphonic acid groups, monomers containing sulphonic acid groups, or combinations thereof.

20. The method according to claim 19, characterized in that the combination of said treatment step with said liquid which contains monomers;
wherein said monomers are selected from the group consisting of monomers containing phosphonic acid groups, and/or monomers containing sulphonic acid groups, or combinations thereof;
and said subsequent polymerisation of the monomers is carried out at least 4 times.

21. The method according to claim 1, characterized in that said monomers containing phosphonic acid groups are removed from the film after said treatment.

22. The method according to claim 1, characterized in that a jigger is used for said treatment of said polymer-comprising shaped bodies.

23. An anisotropic shaped body, obtainable by method of claim 1.

24. The anisotropic shaped body according to claim 23, characterized in that the ratio of maximum modulus of elasticity to minimum modulus of elasticity is at least 2.

25. The anisotropic shaped body according to claim 23, characterized in that said anisotropic shaped body contains at least 50% by weight of polymers containing phosphonic acid groups.

26. The anisotropic shaped body according to claim 23, characterized in that said anisotropic shaped body comprises pores, the size of which is anisotropic.

27. The anisotropic shaped body according to claim 26, characterized in that the ratio of width to height of the pores lies in the range from 1.5 to 5.

28. A proton-conducting polymer membrane containing polymers containing phosphonic acid groups, characterized in that the ratio of maximum modulus of elasticity to minimum modulus of elasticity of said proton-conducting polymer membrane is at least 2.
